(19) United States
(12) Patent Application Publication
(10) Pub. No.: US 2003/0097777 A1
(43) Pub. Date: May 29, 2003

(54) Light-reflecting bird repelling device

(76) Inventor: Oscar R. Campas, Vail, AZ (US)

Correspondence Address: Gavin J. Milczarek-Desai, Durando Birdwell & Janke PLC, 2929 E. Broadway Blvd., Tucson, AZ, 85716, US

(21) Appl. No.: 09/996,185

(22) Filed: Nov. 28, 2001

(51) Int. Cl. A01M 1/00

(52) U.S. Cl. 43/1

(57) ABSTRACT

Bird-repelling devices that reflect light so as to disorient and thereby discourage birds from perching on outside structures are disclosed. The devices feature an inverted “V” or a “W”-shaped reflector that is mounted to the top of a structure, such as a billboard. These reflectors provide a repelling effect while minimizing the reflection of light to the ground, thereby lessening any chance of distraction to motorists or pedestrians caused by glare. The invention may also include a means for pivotally attaching the reflectors, such as by a cog and gear, that allow the reflectors to track the sun or other source of light.

### BACKGROUND OF THE INVENTION

1. Field of the Invention

This invention relates generally to devices for repelling animals. In particular it relates to devices that reflect light such that birds are discouraged from landing or nesting upon objects associated with such devices.

2. Description of the Related Art

There has always been a need for controlling the congregation of birds around external structures, e.g. buildings, due to the unsightly and unsanitary conditions caused by bird droppings. Thus, a number of inventions have been developed to protect structures from such degradation.

Of particular concern to the advertising industry is the damage caused by birds to the numerous billboards, kiosks, and other commercial information-imparting structures. The expense from having to clean up or replace these types of structures is compounded by their typically elevated or otherwise inaccessible locations.

Conventional approaches to the bird-damage problem have involved the use of chemical substances, arrays of spikes, or barriers to prevent landing and/or roosting. Obviously, an ideal repellent should not be harmful to birds or the environment. In this regard, U.S. Pat. No. 5,913,780 discloses a barrier for repelling birds that includes a triangular hollow section having mutually perpendicular sides and an upper surface that is inclined sufficiently to prevent birds from roosting thereupon.

However, unlike building ledges, structures with unobstructed top surfaces, such as billboards, may not be suitable for these types of barriers because persistent birds, most notably pigeons, may simply cling to the top of the triangle since there is no adjacent wall that prevents them for doing so.

Another approach to the related problem of protecting domestic animals from birds-of-prey has involved the use of reflected light. For example, U.S. Pat. No. 1,287,968 issued to Greenleaf discloses a light reflector that features a pyramidal structure and bells for blinding and frightening away chicken hawks and similar birds. While Geenleaf's reflector may be effective for its intended purpose, its design is unnecessarily complicated. Moreover, the pyramidal shape of the reflector causes light to be reflected in such a way that glare may be produced, resulting in potential distraction for motorists or pedestrians.

Thus, there remains a need in the art for an effective light reflection-based, bird-repelling device that is simple in design and use, inexpensive to produce, and minimally distracting to humans.

### BRIEF SUMMARY OF THE INVENTION

The invention relates in general to devices that reflect light so as to disorient and thereby discourage birds from perching on outside structures. More particularly, the invention involves an inverted “V” or a “W” shaped reflector that preferably is mounted to the top of a structure, such as a billboard. These reflectors provide a repelling effect to birds while minimizing the reflection of light to the ground, thereby lessening the chance of distraction caused by glare to motorists or pedestrians. The invention may also include means for pivotally attaching the reflectors such that they can be positioned to track the sun or other source of light.

Thus, the bird-repelling device according to the present invention substantially departs from the conventional concepts and designs of the prior art by providing light-reflecting apparatuses that are inexpensively produced and easily placed on billboards and other elevated structures, such as canopies, building ledges, and the like. Moreover, the invention is harmless and does not require power to operate.

A principal objective of this invention is to provide a reliable but simple bird-repelling device.

Another objective of the invention is to provide a bird-repelling device that is easy and inexpensive to install upon billboards and other difficult to access structures.

Another goal is to provide a new and improved bird-repelling device that is non-toxic and more aesthetically pleasing then spikes and other conventional forms of bird repelling.

Yet another objective is to provide a light-reflecting bird-repelling device for billboards that produces a minimal amount of glare to passing motorists or pedestrians.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced. All publications cited are hereby incorporated by reference in their entirety herein.

### BRIEF DESCRIPTION OF THE DRAWINGS

FIG. 1A schematically depicts a side elevation view of a preferred embodiment of the invention attached to a billboard.

FIG. 1B schematically depicts a frontal view of the reflector of FIG. 1A without a baseplate.

FIG. 2 schematically depicts in side elevation view a variation of the embodiment shown in FIG. 1.

FIG. 3 schematically depicts a side elevation view of the embodiment of FIG. 2 using an alternative means for attachment.

FIG. 4 schematically depicts a second preferred embodiment showing an optional gearing system for tracking a source of light.

### DESCRIPTION OF THE PREFERRED EMBODIMENT OF THE INVENTION

The present invention generally features structurally unique reflectors that operate to repel birds from perching on billboards and other elevated structures. Preferably, an inverted “V” or a “W-shaped” reflector is mounted to the top surface of the structure and is believed to discourage birds from landing on or nearby through a disorienting effect caused by the reflection of light.

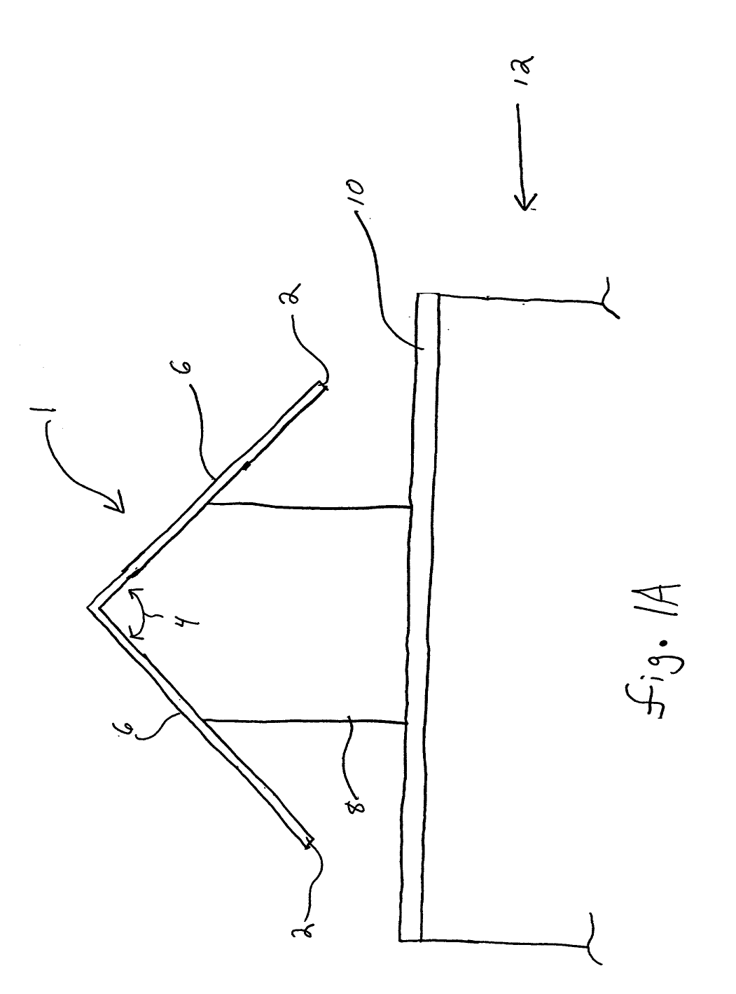

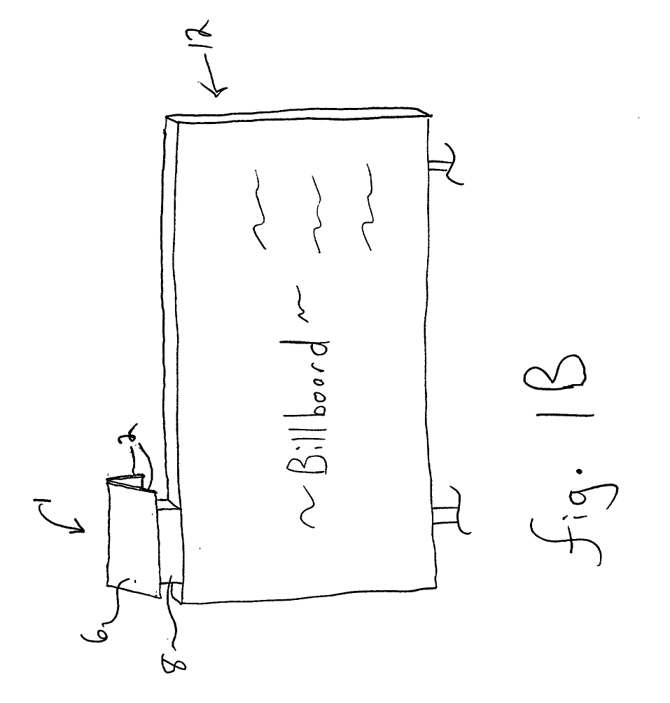

Referring to the drawings, wherein like parts are designated throughout with like numerals, FIG. 1A illustrates in side elevation view a preferred reflector 1 according to the invention. The reflector 1 includes two substantially rectangular planar members 2 that slope downwardly to form an angle 4 therebetween. Preferably, the angle 4 is approximately 90 degrees or greater so that the occurrence of glare is minimized or eliminated for persons at a frame of reference that is lower in height when compared to the reflector 1.

The planar members 2 each have an outwardly facing reflective surface 6 for reflecting light to scare the birds away from the protected structure. Preferably, the reflective surface is a mirror. However, any bright, metallic, or mirror-like surface may be used in accordance with the invention.

Preferably, the reflector 1 is then held in place by a support 8. In this particular embodiment, the support 8 also includes a baseplate 10. The baseplate 10 assists in the mounting of the invention to the top of a billboard 12 by providing a large surface area for the application of bonding agents or adhesives. Alternatively, the invention may be mounted directly by the support 8 (i.e. without a baseplate 10) through any conventional means, including, but not limited to, nails, screws, magnets, or a sleeve made to slip over a billboard of a particular configuration. Thus, FIG. 1B schematically depicts a frontal view of the reflector of FIG. 1A, except that the support 8, rather then a baseplate, serves to directly attach the reflector to the billboard 12.

Of course, the planar members 2 may be of unitary construction rather than two or more pieces that have been joined together. Moreover, the invention may assume shapes other than rectangles, for example, the planer members 2 may be circular or triangular in appearance.

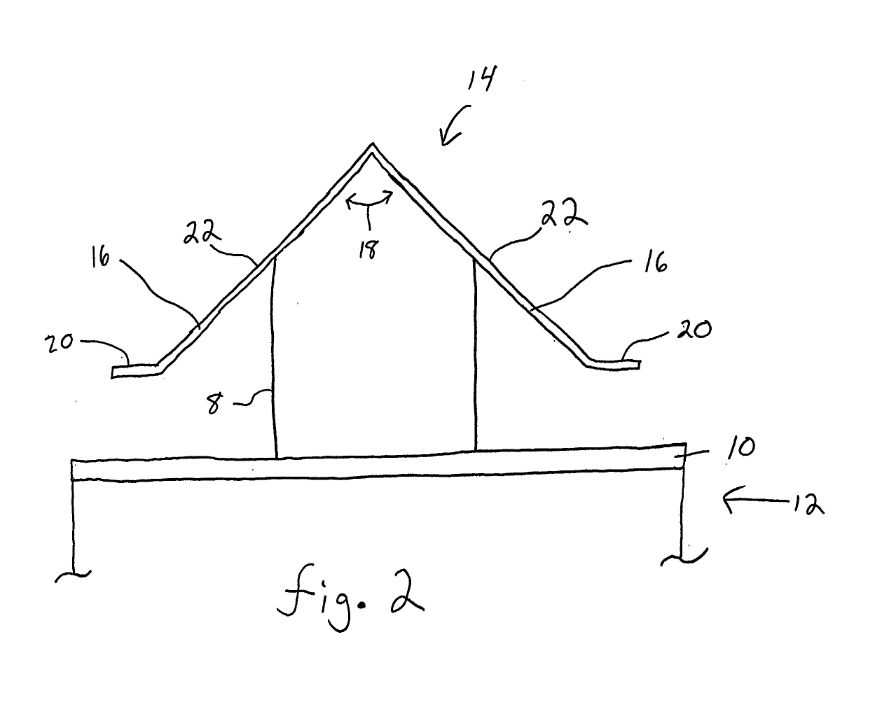

Turning to FIG. 2, a modified reflector 14 based on the embodiment of FIG. 1 is shown. Reflector 14 has two substantially rectangular planar members 16 that slope downwardly to form an angle 18, which is preferably greater than 90 degrees. Each planar member 16 terminates with a substantially flat end 20. The flat ends 20 are roughly parallel to the baseplate 10 and are thought to further reduce any glare experienced by observers on the ground by further directing some reflected light upward. The reflector 14 may fabricated as a single unit that covers the top of a billboard or other structure, or it may be manufactured as individual subunits that are placed at predetermined intervals, such as every six inches.

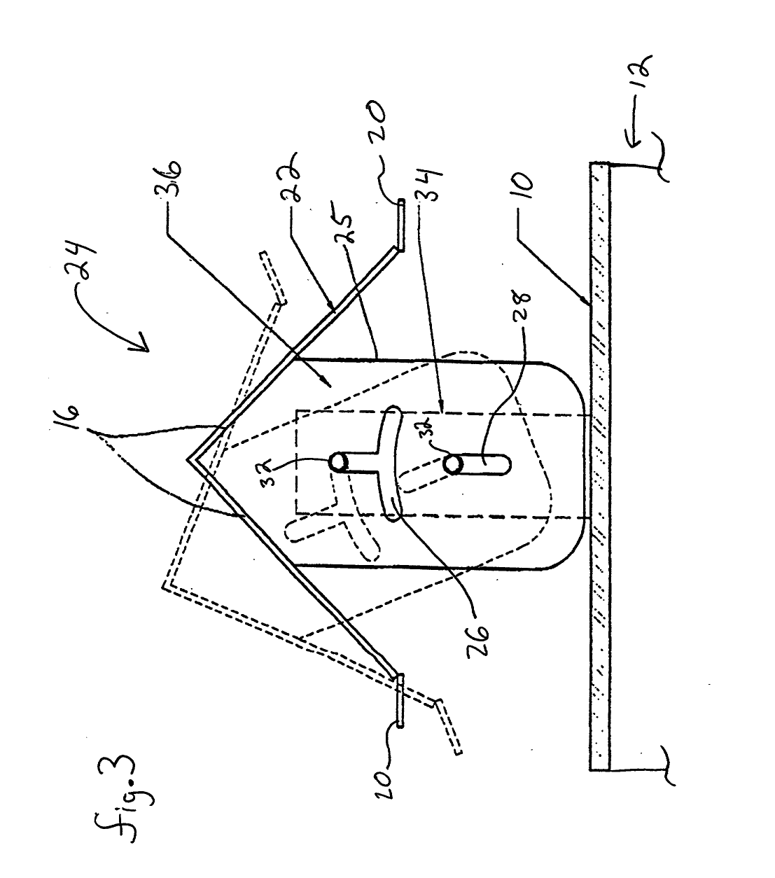

In FIG. 3, an alternative means for mounting the embodiment of FIG. 2 is depicted. Reflector 24 is connected to support bracket 25, which contains an upper slotted aperture 26 and a lower aperture 28. Both slotted aperture 26 and aperture 28 are adapted to receive pins 32, which are located on a second support member 34 that is mounted to billboard 12 by baseplate 10.

The configuration of the slotted aperture is such that the reflector 24 may be pivoted to one of three alternate positions (one of which is generally designated 36 and shown in phantom line). Thus, the position of reflector 24 may be adjusted to better reflect light and/or reduce glare depending on the desired effect.

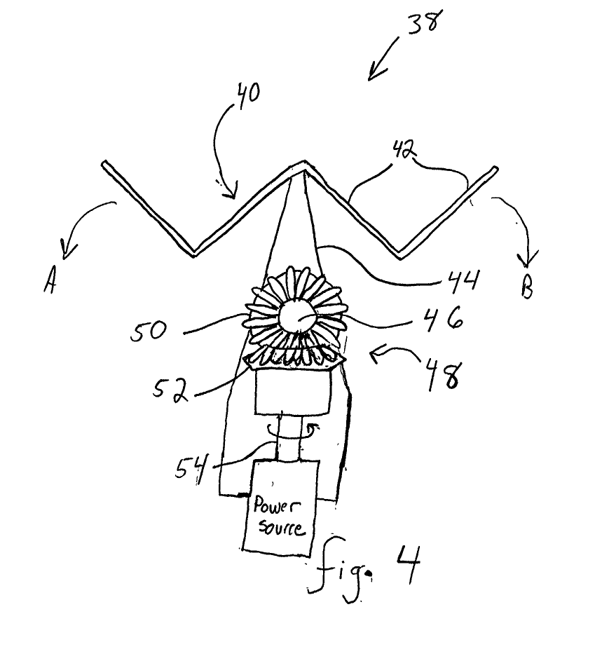

Turning to FIG. 4, a more elaborate embodiment of the invention is depicted. Reflector 38 includes a W-shaped member 40 having upward reflecting surfaces 42. The W-shaped member is attached to a support member 44, which is fixedly attached to rod 46.

Although not clearly shown, support member 44 contains a hole through which rod 46 is rotatably mounted.

At the end of rod 46 there is a gear and cog wheel arrangement 48, which is made up of vertical beveled gear 50 (secured to rod 46) and horizontal beveled gear 52 (secured to drive shaft 54). In response to a power source, drive shaft 54 rotates beveled gear 52 such that beveled gear 50 is turned either clockwise or counter-clockwise. Since support member 44 is fixed to rod 46, the reflector 40 responds by pivoting in either direction A or B. Thus, the reflector 38 may be remotely or otherwise controlled to track the sun or other light source.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

I claim:

1. An apparatus for keeping birds away from a structure comprising:
two substantially planar members joined along an edge and sloping to form an angle therebetween, said substantially planar members having outwardly facing reflective surfaces for reflecting light; and,
a support member connecting the substantially planar members to said structure.

2. The apparatus of claim 1, wherein said outwardly facing reflective surfaces are mirrors.

3. The apparatus of claim 1, wherein said support member includes a baseplate.

4. The apparatus of claim 1, wherein said support member further includes a means for tracking a source of light.

5. The apparatus of claim 4, wherein said means for tracking a source of light comprises two pins in fixed relationship to said structure and two slotted apertures in said support member, such that the apparatus is freely supported by engaging said pins in said apertures and is pivotally adjustable between alternative relative positions of the pins in the apertures.

6. The apparatus of claim 4, wherein said means for tracking a source of light comprises a gear and cog wheel arrangement.

7. The apparatus of claim 1, wherein said substantially planar members include an outwardly extending flat end.

8. The apparatus of claim 1, wherein said angle is about 90 degrees.

9. An apparatus for keeping birds away from an object comprising:
two substantially planar members sloping downwardly to form an angle therebetween, said substantially planar members having outwardly facing reflective surfaces for reflecting light.

10. The apparatus of claim 9, wherein said outwardly facing reflective surfaces are mirrors.

11. The apparatus of claim 9, wherein the apparatus includes a support member that supports the substantially planar members.

12. The apparatus of claim 11, wherein the support member includes a baseplate.

13. The apparatus of claim 11, wherein said support member is connected to a means for tracking a source of light.

14. The apparatus of claim 13, wherein said means for tracking a source of light comprises two pins in fixed relationship to said structure and two slotted apertures in said support member, such that the apparatus is freely supported by engaging said pins in said apertures and is pivotally adjustable between alternative relative positions of the pins in the apertures.

15. The apparatus of claim 13, wherein said means for tracking a source of light comprises a gear and cog wheel arrangement.

16. The apparatus of claim 9, wherein said substantially planar members include an outwardly extending flat end.

17. An apparatus for keeping birds away from an object comprising:
a planar member having a substantially W-shaped cross-section, said planar member having upwardly facing reflective surfaces for reflecting light.

18. The apparatus of claim 17, wherein said apparatus includes a support member connected to the planar member for mounting said member to said structure.

19. The apparatus of claim 17, wherein said upwardly facing reflective surfaces are mirrors.

20. The apparatus of claim 18, wherein said support member further includes a baseplate.

21. The apparatus of claim 18, wherein said support member is connected to a means for tracking a source of light.

22. The apparatus of claim 21, wherein said means for tracking a source of light comprises a gear and cog wheel arrangement.
